(19) United States
(12) Patent Application Publication
(10) Pub. No.: US 2024/0311822 A1
(43) Pub. Date: Sep. 19, 2024

(54) DECENTRALIZED FINANCIAL TECHNOLOGY BLOCKCHAIN

(71) Applicant: Financial Cloud Innovations Inc., Anaheim Hills, CA (US)

(72) Inventors: Alfredo Campana, Miami, FL (US); Timothy Griffith, Yorba Linda, CA (US); Jeffrey Griffith, Anaheim Hills, CA (US); Michael Griffith, Anaheim Hills, CA (US)

(21) Appl. No.: 18/608,510

(22) Filed: Mar. 18, 2024

Related U.S. Application Data
(60) Provisional application No. 63/458,098, filed on Apr. 8, 2023.
(60) Provisional application No. 63/452,965, filed on Mar. 17, 2023.

(51) Int. Cl. G06Q 20/38; G06Q 20/10; G06Q 20/36; G06Q 40/03

(52) U.S. Cl. CPC G06Q 20/389; G06Q 20/10; G06Q 20/367; G06Q 20/38215; G06Q 20/3827; G06Q 40/03

(57) ABSTRACT

On a FinTech platform, integrated blockchain networks and Interplanetary file system (IPFS) technologies provide daily servicing and reporting activities to users of the Platform. Users, such as stakeholders, customers and financial institutions, interact with the Integrated Platform through both private and public networks without a middleman. A platform user uploads information associated with a physical asset, such as a mortgage/deed, loan information, or the like, to the platform. The platform records the uploaded information, simultaneously, to a private blockchain and an IPFS of the platform. A collateralized non-fungible token (cNFT) is generated to represent the physical asset and is also recorded to the private blockchain and the IPFS. To transfer ownership external to the platform, the cNFT is converted to a public cNFT and migrated to a public blockchain.

### CROSS-REFERENCE TO RELATED APPLICATIONS

This application claims the benefit of U.S. Provisional 63/458,098, filed Apr. 8, 2023, and U.S. Provisional 63/452,965, filed Mar. 17, 2023, both of which are hereby incorporated by reference as if submitted in their entireties.

### BACKGROUND

Blockchain technology is a decentralized, distributed ledger technology that allows for the secure and transparent recording of transactions across a network of computers. Each block in the blockchain contains a timestamp and a link to the previous block, forming a chronological chain of blocks. These blocks are immutable, meaning once a transaction is recorded, it cannot be altered or deleted without consensus from the network participants. This immutability ensures the integrity and security of the data stored on the blockchain.

One of the key features of blockchain is its consensus mechanism, which enables network participants to agree on the validity of transactions without the need for a central authority. This consensus is typically achieved through mechanisms like proof of work or proof of stake, where participants compete to validate transactions and add them to the blockchain. Blockchain technology has widespread applications beyond cryptocurrencies, including supply chain management, voting systems, decentralized finance, and digital identity verification, due to its ability to provide transparency, security, and efficiency in various processes.

IPFS, or the InterPlanetary File System, is a decentralized protocol designed to create a more resilient and efficient way to store and share content on the internet. Unlike traditional HTTP-based systems where content is stored on centralized servers, IPFS utilizes a peer-to-peer network where each node stores a portion of the shared data, making it more resistant to censorship and failure. In IPFS, files are identified by unique cryptographic hashes, enabling efficient content addressing and retrieval.

When a file is added to IPFS, the file is broken down into smaller chunks, each of which is assigned a unique hash. These chunks are then distributed across the network, with redundancy built-in to ensure that even if some nodes go offline, the content remains accessible. When a user wants to retrieve a file, they use the assigned hash to locate the closest nodes storing the chunks and retrieve the chunks in parallel, resulting in faster downloads. IPFS represents a paradigm shift in how content is stored and accessed on the internet, offering greater security, resilience, and efficiency compared to traditional centralized systems.

Present-day financial technology platforms suffer from several issues such as a lack of transparency, scalability, and compliance reporting, in part because these systems rely on the centralization of infrastructure and data. Further, current financial technology platforms often require a mirror twin, resulting in multiple areas of friction and delay in uploading, inputting, analyzing, and transferring the necessary data for financial transactions.

### BRIEF DESCRIPTION OF THE DRAWINGS

For a detailed description of various examples, reference will now be made to the accompanying drawings in which:

FIG. 1A shows an example blockchain network architecture in accordance with one or more embodiments.

FIG. 1B shows an example Interplanetary File System (IPFS) architecture in accordance with one or more embodiments.

FIG. 1C shows an example network architecture integrating a blockchain network architecture and an IPFS architecture in accordance with one or more embodiments.

FIG. 2A shows an example network architecture illustrating a network of blockchains within an ecosystem in accordance with one or more embodiments.

FIG. 2B shows an example network architecture illustrating the integration of services within the ecosystem in accordance with one or more embodiments.

FIG. 2C shows an example network architecture for service transactions within the ecosystem in accordance with one or more embodiments.

FIG. 3 shows an example network architecture for a network of blockchains within an ecosystem in accordance with one or more embodiments.

FIG. 4 shows an example implementation of parachain in accordance with one or more embodiments.

FIGS. 5A and 5B illustrate an example certificate of authenticity in accordance with one or more embodiments.

FIG. 6 is a flow chart illustrating a method of managing digital assets using an integrated structure of blockchain networks and an Interplanetary File System (IPFS) in accordance with one or more embodiments.

FIG. 7 shows, in block diagram form, an example electronic computing device in accordance with one or more embodiments.

### DETAILED DESCRIPTION

The following description relates to technical improvements to asset management using blockchain networks and interplanetary file system (IPFS) technologies. Described herein are systems and methods directed to the integration of a Blockchain network structure and Interplanetary File System (IPFS) technology, hereinafter the “Integrated Platform.” The systems and methods may provide, for example, daily servicing and reporting activities to users of the Integrated Platform. Users may include, but are not limited, stakeholders, customers, financial institutions, or any other similar entity that may use the Integrated Platform to manage assets. In some embodiments of the disclosed technology, users may interact with the Integrated Platform through both private and public networks without a middleman. The disclosed systems and methods of the Integrated Platform provides an architecture that promotes scalability, traceability, security, automatization, decentralization of data, and trust in the financial services sector.

In some embodiments of the disclosed technology, the systems and methods of the Integrated Platform make loan servicing more efficient, automated, and scalable. Additionally, with the integration of API technology, encryption capabilities, Interplanetary File System (IPFS) technologies, and Smart Contracts, the Integrated Platform gives users the ability to upload and manage transactions and financial loan data into a private, secured Blockchain. Further, the private, secured Blockchain of the Integrated Platform produces a forensic style cataloguing of actions acting as a Zero Knowledge Proof for audit purposes. Zero Knowledge Proof for auditing allows one party (the prover) to prove to another party (the verifier) that a statement is true without revealing any additional information beyond the validity of the statement itself. This ensures privacy and confidentiality while maintaining the integrity of the auditing process. These entries are both accounted for and memorialized as an undisputed record.

The Integrated Platform disclosed herein provides a singular access point for users to upload, view, share, and transfer information contained in their portfolio or for an individual asset. Among the numerous benefits gained through the Integrated Platform's ecosystem and protocols, the merging of Blockchain architecture and IPFS technology significantly increases security, efficiency, transparency, access, and compliance capacity. By leveraging the benefits of Blockchain and IPFS, financial institutions can better meet the evolving needs of customers and stay competitive in an increasingly digital world.

In some embodiments, the Blockchain technology uses advanced cryptographic algorithms to secure transactions and data by encrypting all the data uploaded to the Blockchain. It also uses a distributed ledger system that allows for transparent and immutable recording of every transaction recorded on the Blockchain.

In some embodiments, users of the Integrated Platform can host a server node which includes a copy of the data that the Integrated Platform's Blockchain hosts. These decentralization features make it more difficult for unauthorized users to commit fraud, engage in hacking activities, and prevents the ability to alter the data. This enhanced security builds a trustless environment and provides confidence for users, resulting in an assured reliability regarding the accuracy of the data presented without the need of central authority figures.

In some embodiments, the Integrated Platform provides an integration of Blockchain technology and Smart Contracts which is capable of automating financial processes such as payment processing, investor disbursements, regulatory reporting, consumer notifications, securitizations, transfer of ownership, and distribution waterfalls. By removing intermediaries and streamlining these processes, the Integrated Platform's Blockchain can significantly reduce the time and cost of transactions. This helps to decrease the turnaround time, increase the efficiency of financial services and improve the overall customer experience.

In some embodiments, the Integrated Platform's Blockchain technology provides a transparent and auditable record of every single transaction ever written on the Blockchain. Additionally, the Integrated Platform may include one or more tools to communicate with the Blockchain. For example, a Blockchain Explorer allows users to search through each transaction. This process helps audit each transaction, which increases transparency and accountability by helping reduce the risk of errors and fraud. All transactions recorded have a Responsible Party on an immutable ledger and these records can be segmented by businesses, by individual accounts, or by any specific transaction.

In some embodiments, the Integrated Platform's combination of Blockchain and IPFS technology enables peer-to-peer transactions without the need for intermediaries. This helps increase access to financial services, particularly for businesses transacting with other companies, customers, or those seeking to report to government agencies. With the use of IPFS, which is a decentralized peer-to-peer file sharing technology, secure sharing that ensures tamper-proof relaying of large amounts of data or files is enabled.

In addition to increased access, the simultaneous use of the Integrated Platform's Blockchain and IPFS technology helps financial institutions comply with regulatory requirements by providing a transparent and auditable record of transactions and documents. This reduces the risk of non-compliance and improves the speed and accuracy in the necessary regulatory reporting.

In some embodiments of the disclosed technology, the Integrated Platform may include Back Up Servicing. Back Up Servicing may include, for example, the backing up of customer's servicing data from any Loan Servicer in the world to the Private Blockchain and Interplanetary File System (IPFS) of the Integrated Platform. When customer servicing data is recorded to both the Private Blockchain and the IPFS, a Private Digital asset may be generated and is immutable. Because this immutable asset is backed up to the Private Blockchain and IPFS of the Integrated Platform, the customer can move their portfolio to any servicer. For example, if anything happens to their current servicer (e.g., become unresponsive, go out of business, get hit by a natural disaster, become subject to ransomware or hacking, etc.) their entire portfolio is safe and up to date on the Private Blockchain and IPFS. All the customer needs is their Private Digital asset, move to any servicer, and pick up where they left off via the Back Up Servicing service using their Private Digital asset to recover their customer servicing data. In one example, the customer may pick up where they left off while completing a loan application, or the like.

### Architecture Functionality and Diagrams

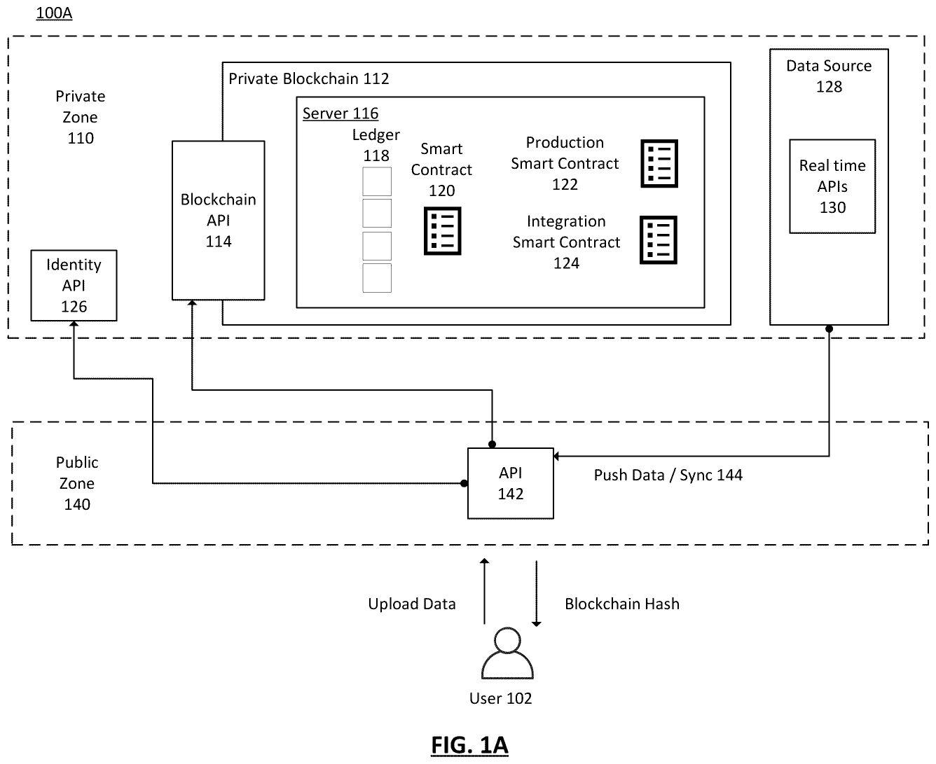

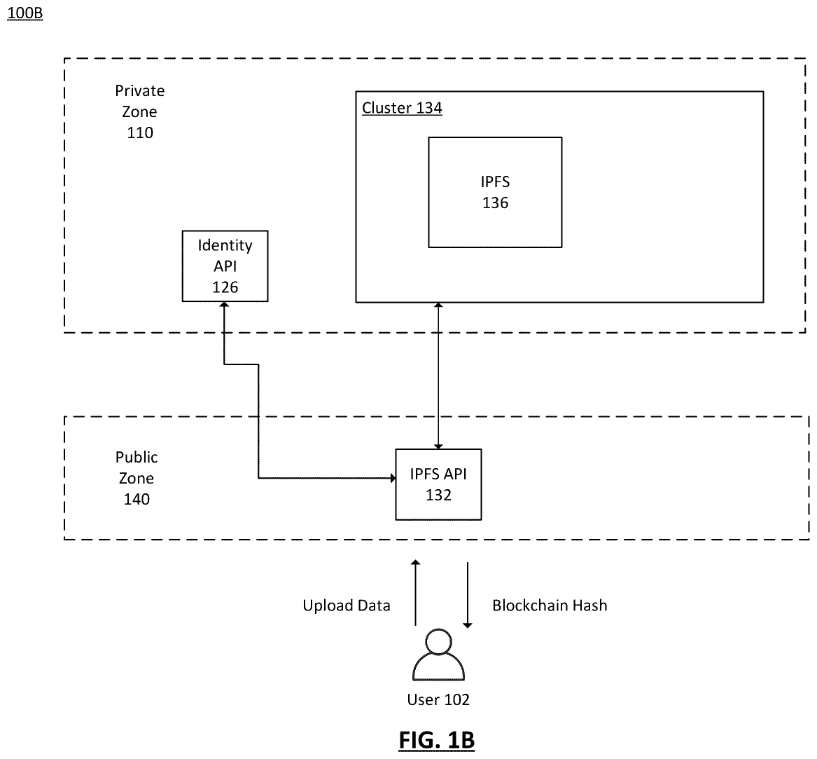

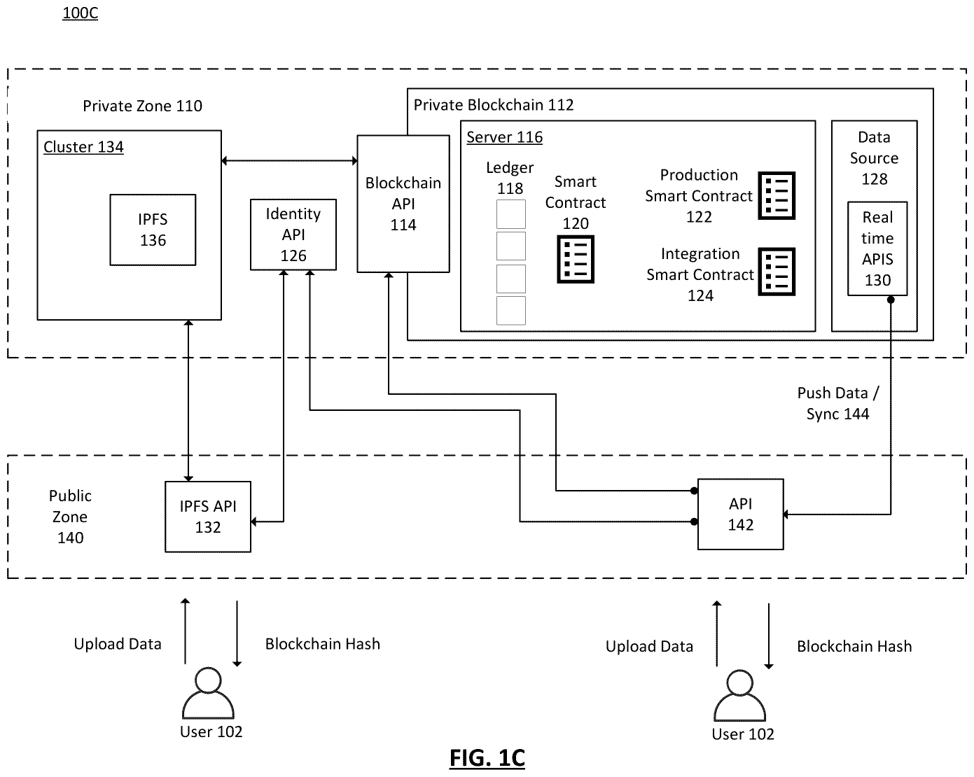

Referring now to FIG. 1A, an exemplary blockchain architecture 100A is illustrated. In this example, a user 102, through a website or API 142 located in a Public Zone 140 may interact with a Private Blockchain 112 which has a block structure of a financial instrument. The public API 142 connects to the Blockchain API 114 which talks to the Smart Contract 120 that writes to the blockchain ledger 118. An Identity API 126 may be used to control access to other systems within the Private Zone 110. For example, data uploaded by user 102 to API 142 may be used to verify the identity of the user using identity API 126. Once verified, user 102 may be permitted to upload data, such as data pertaining to an asset owned by the user which may be recorded on server node 116. Server node 116 may include, for example, a copy of a distributed ledger 118 and one or more smart contracts, such as smart contract 120, production smart contract 122, integration smart contract 124, or the like. Once a record has been made on ledger 118 for user 102, a blockchain hash may be returned to the user. The blockchain hash information may indicate, for example, identification information for the user's record on ledger 118. In one example, the blockchain hash may be sent via a push data/sync 144 to user 102 via a real time API 130 of data source 128. Additionally, or alternatively, the blockchain hash may be used to verify the integrity of the record on ledger 118 or view transaction details via a blockchain explorer.

Referring now to FIG. 1B, an exemplary IPFS architecture 100B is illustrated. In this example, a user 102, connects to a website or IPFS API 132 in Public Zone 140 to upload files through the IPFS API 142. An Identity API 126 may be used to control access to other systems within the Private Zone 110. For example, data uploaded by user 102 to API 142 may be used to verify the identity of the user using identity API 126. Once verified, user 102 may be permitted to upload data to systems within Private Zone 110, such as IPFS 136 within Cluster 134. Once the user's data upload is complete, IPFS 136 may return a hash value to user 102 via IPFS API 132. The hash value returned to the user 102 may be used for subsequent retrieval of the uploaded data from IPFS 136.

Turning now to FIG. 1C, an exemplary integrated IPFS and Blockchain architecture 100C is illustrated. Diagram 100C combines the architecture of diagram 100A with the architecture of diagram 100B. As illustrated, a user 102 may be provided with a singular access point to upload, view, share, and transfer information using the IPFS and Blockchain architecture described herein. In this example, the integrated IPFS 136 and Blockchain 112 may be used to record all transaction and documents within a single ecosystem in at least two ways. First, IPFS 136 and Blockchain 112 may be used as a sole source of storage. Second, direct server readers may be used to post transactions to one or more APIs, such as IPFS API 132, Blockchain API 114, and/or API 142, which may then post to IPFS 136 and Private Blockchain 112.

In some embodiments, the Integrated Platform can be used to optimize analyzing a portfolio. The suite of tools allow users to combine blockchain technology and Interplanetary File System (IPFS) features to add transparency, security, and efficiency to the process in which a third-party servicer is enlisted to monitor the lender's data alongside the original loan servicer. This process can occur either on a temporary or permanent basis, particularly in the event that the primary servicer is unable to fulfill its obligations.

The disclosed Integrated Platform may include multiple Smart Contracts 120 that enables Back Up Servicing capabilities by recording and triggering actions based on servicing transactions and modifying records within the primary servicer's systems. The user can select numerous ways in which the Smart Contracts can operate, providing both the user and Backup Servicer efficient opportunities to track their data. The additional Smart Contracts allow Data Migration to the Back Up Servicer, provide Due Diligence of required collateral documents, Monitor and Alert users on what data has been transmitted, upload transactions to the blockchain, and save files to the Interplanetary File System (IPFS).

Back Up services of the disclosed ecosystem can be easily implemented on all collateral loans by using a suite of features provided by the ecosystem. Users can access these benefits by either using report downloads or connecting APIs that will directly send data to the lender or creditor from their primary servicer and transferred to the ecosystem. As an alternative, the Integrated Platform can work directly with the primary servicer to gain information from the servicing systems using the primary servicer's APIs or other types of reporting capabilities to download their information directly into the Integrated Platform's Back Up blockchain systems, such as Archival Storage 222, Blockchain Backup 224, Additional Storage 226, or the like.

The disclosed Integrated Platform's loan servicing Back Up systems can contain all loan collateral information such as origination documents, legal documents, and all servicing documents and histories. The specific information memorialized can be as extensive as the lender or creditor desires to download to the Integrated Platform on behalf of their Back Up Servicer. Some possibilities and options for the lender include uploading complete collateral files, which would allow all documents to be viewable in one location, while also having the capabilities to share or transfer data to others if it becomes necessary to transfer loans from the primary servicer to the Back Up Servicer. Additionally, these features allow the lender to transfer the recorded data upon sale of a single loan or an entire portfolio instantly at any time of the day or year.

### Financial Technology Network

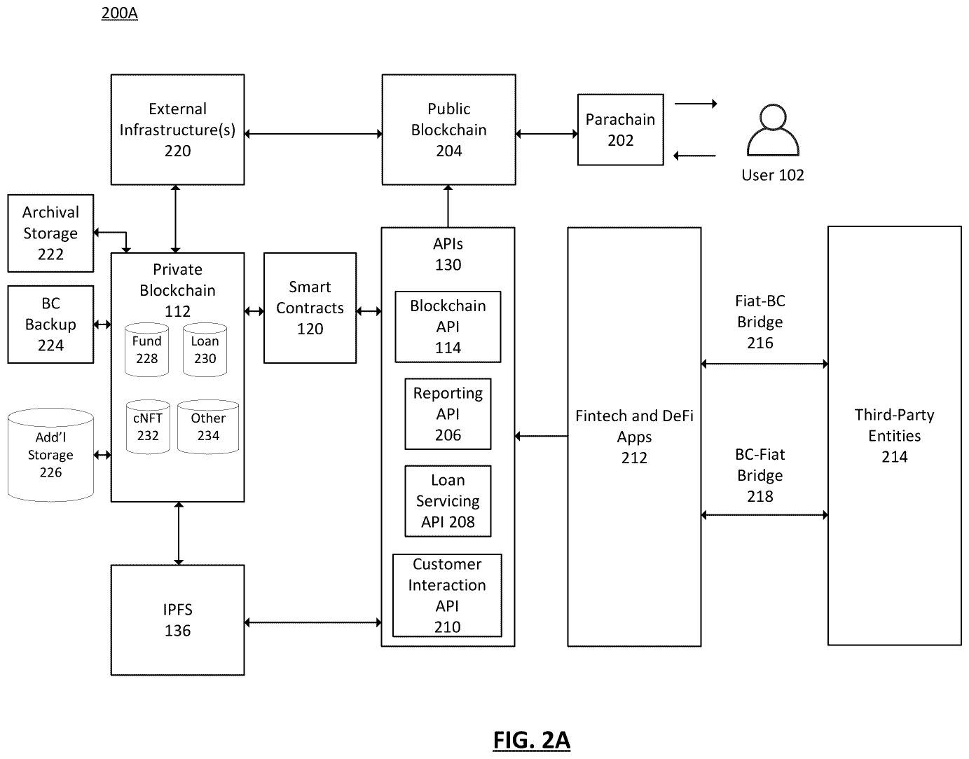

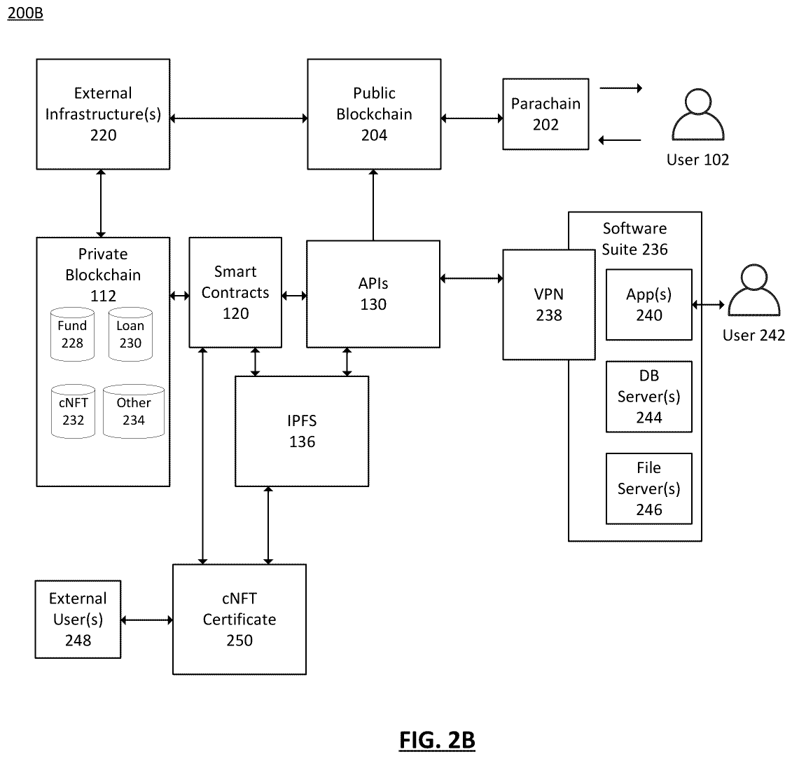

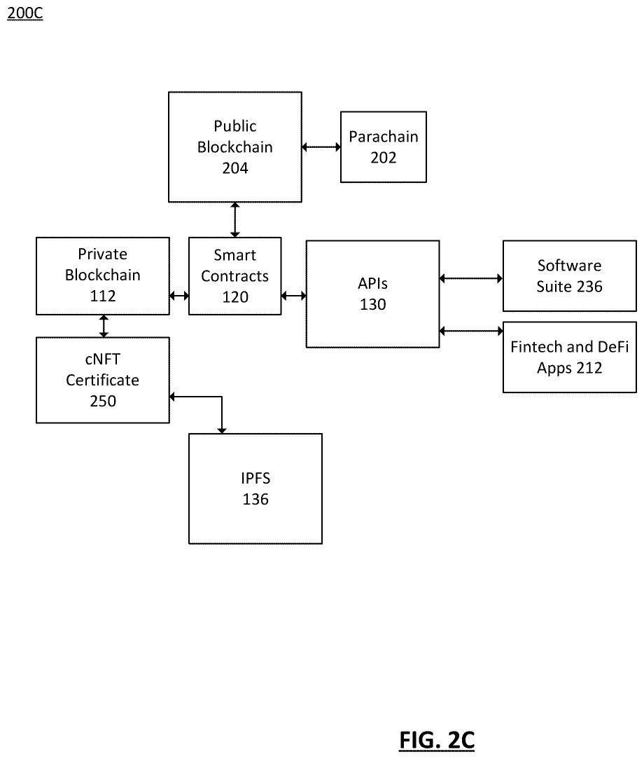

FIG. 2A illustrates an exemplary Financial Technology (Fintech) ecosystem diagram 200A that spans from Financial Institution users, such as user 102, all the way to external users, such as Third-Party Entities 214. In one example, a service, such as Lender Services provides an example of how a financial institution can fully integrate to the disclosed Integrated Platform. Lender Services, using one or more Fintech and DeFi Apps 212 may use the Integrated Platform's technology to record all its financial transactions and financial documents inside the ecosystem in two ways. First, the Integrated Platform's Blockchains 112 and Interplanetary File System (IPFS) 136 may be used as a source of storage. Additionally, or alternatively, transactions may post transactions with direct server readers to the Integrated Platform's APIs and then the APIs can post to the Integrated Platform's IPFS and Blockchain. Either of these processes allow financial institutions to maintain the use of their own technology and processes by using one or more APIs 130 provided by the ecosystem. APIs 130 may be used in conjunction with one or more of the Fintech and DeFi Apps 212 to complete transactions within the ecosystem. APIs 130 may include, for example, a blockchain API 114 to record transactions on private blockchain 112 or public blockchain 204, reporting API 206 to generate reports to entities 214 or user 102, loan servicing API 208, customer interaction API 210, or the like.

### Multi-Currency Bridge

The Integrated Platform may include a Multi-Currency Bridge that provides access to exchanges in a convenient way for financial institutions or financial institution clients. For example, Fiat-BC Bridge 216 or BC-Fiat Bridge 218. As a result, this allows financial transactions to be conducted in a wide range of fiat and cryptocurrency markets.

For example, a borrower can pay their mortgage to a bank (e.g., US Bank®) that is denominated in US Dollars, but can make their payment using their crypto wallet. The Integrated Platform converts the crypto funds to US Dollars and applies the payment in the correct form of currency. This multi-currency bridge will open opportunities for new applications in advanced trading features such as margin trading and stop-loss orders.

FIG. 2B illustrates an exemplary diagram 200B of integration of an entity within Integrated Platform's network. In one embodiment, the entity, such as user 242, may connect to the Integrated Platform's Blockchain Architecture without disrupting its day-to-day processes and while maintaining existing technology. For example, user 242 may be provided with a software suite 236 that connects to the Integrated Platform via a secure connection, such as VPN 238. Software Suite 236 may provide one or more app(s) 240, Database Server(s) 244, File Server(s) 246, or other software applications so the user 242 may interact with the Integrated Platform to conduct transactions as described herein.

FIG. 2C illustrates an exemplary diagram 200C of an architecture for financial transactions in the disclosed Integrated Platform. Diagram 200C illustrates an example ecosystem for financial transactions and illustrates how fintech, APIs, Blockchains, Smart Contracts, and the Interplanetary File System (IPFS) network work together to register every financial transaction. This example diagram illustrates how a user may interact with the Integrated Platform using either a software suite 236 or one or more Fintech and DeFi Apps 212 via APIs 130.

This exemplary architecture promotes scalability, traceability, security, automatization, decentralization of data, and transparency. Additionally, the exemplary architecture provides flexibility and accessibility for its users. For example, private and public entities can connect through APIs 130 and send financial transactions directly to the Integrated Platform's Private Blockchain 112. Additionally, if an institution creates a financial asset, such as a newly originated loan, the collateral documentation and additional attachments can be uploaded to the IPFS network 136. Then, an IPFS API 132 uploads to a Smart Contracts portal 120 that uses an IPFS hash to record the data in near-real-time to the Private Blockchain 112 of the Integrated Platform.

In some embodiments, a cNFT (Collateralized Non-Fungible Token) may be provided. The cNFT summarizes key asset information and acts as a Zero Knowledge Proof that attests to an asset's transactions, ownership, and collateral documentation. If an asset owner decides to sell or transfer one of their assets, they can use the cNFT to publish the asset's information in either the Private 112 or Public Blockchain 204 of the Integrated Platform to enable the transfer of the cNFT to another vault holder with a portfolio- or asset-specific key. Additionally, the user can publish the financial asset to an external Blockchain by taking advantage of the Integrated Platform's ability to connect to other public Blockchains by using a Parachain 202.

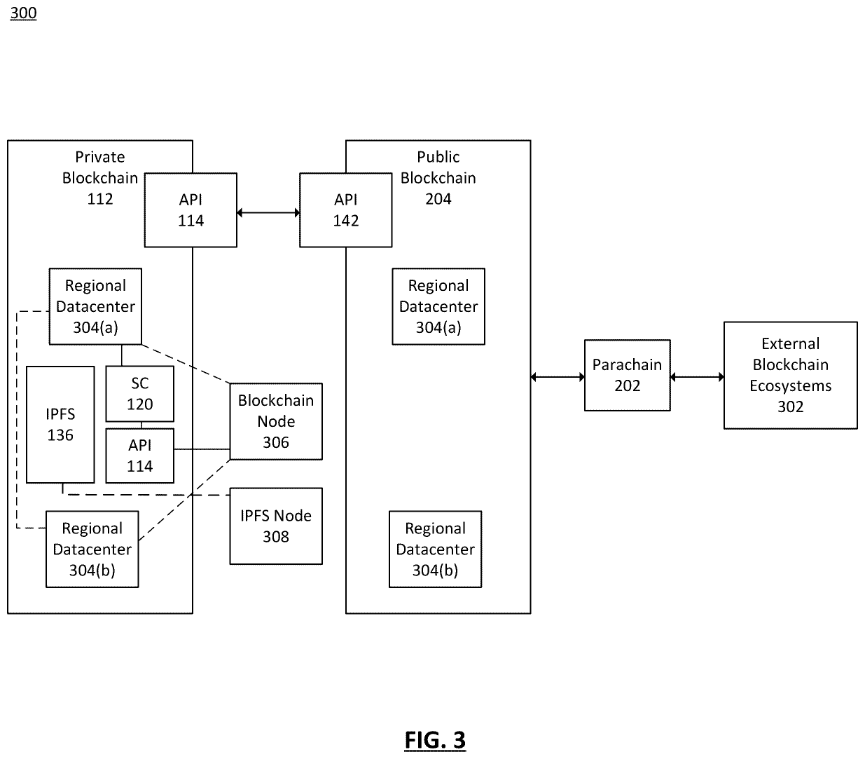

Referring to FIG. 3, an exemplary structure 300 of Blockchain networks addresses important security, permissions, accessibility, performance, and transparency needs for the financial industry. The architecture, for example, may operate on multiple private Blockchains 112. This network of Blockchains emphasize encryption and accessibility so that financial institutions can overcome concerns about the risks of having their financial data hosted on public servers and can instead integrate into a private network of Blockchains of the Integrated Platform.

The Integrated Platform allows institutions to host their own Interplanetary File System (IPFS) and Blockchain nodes in both the private and public Blockchain. Further, the integration of Bridge and Smart Contracts of the Integrated Platform allow a company's specific private Blockchain and the public Blockchain to communicate. The Private Blockchain of the Integrated Platform only takes assets to the Public Blockchain if the asset owner wants to share or transfer the asset from the private system.

FIG. 3 illustrates an exemplary diagram 300 of an architecture for adding an additional layer of accessibility. Diagram 300 illustrates how a Parachain 202 adds an additional layer of accessibility when used to connect a Public Blockchain 204 to external Blockchain ecosystems, such as Private Blockchain 112. This process permits the Integrated Platform's private Blockchain users to access additional nodes, such as Blockchain node 306, that allow for additional flexibility in managing the asset. For example, a fund using the Private Blockchain 112 of the Integrated Platform can trade financial assets with another private Blockchain user or can list those assets for sale in the Public Blockchain 204, which would provide access to users from all other external Blockchain ecosystems.

In some embodiments, different types of financial institutions can integrate with the Integrated Platform's deployed Blockchain environment. In some embodiments of this example integration, a user may access a software suite 236 offered by the Integrated Platform which is already integrated to the Blockchain. Alternatively, a user may use their own software and use one or more APIs 130 of the Integrated Platform to connect to the Blockchain 112 and Interplanetary File System (IPFS) 136 in order to record their financial data.

For example, a first Financial Institution may use their existing licensed applications of the Integrated Platform which provide instant access to the Blockchain node 306 and IPFS node 308. This data is already stored in the Integrated Platform's Blockchain network and IPFS nodes but can also be centrally housed on an internal business server in order to centralize the information. For the first Financial Institution, this approach may benefit their company, as the integration expands and increases the security of the Integrated Platform as a whole.

In another example, a second Financial Institution is not a licensed user of the applications of the Integrated Platform as this company relies on their own existing technology. This company can still integrate into the Integrated Platform's Private Blockchain 112 and IPFS Network 136 with their current technology and access the benefits of the ecosystem through the use of one or more APIs 114. By taking this route, a financial institution can still participate in the ecosystem and host from zero to hundreds of nodes. Even if a financial institution does not host a single node or use any of the applications of the Integrated Platform, once they are vetted as a licensed financial institution, they may be onboarded and gain access to the benefits of the ecosystem.

The disclosed ecosystem includes an Interplanetary File System (IPFS). An IPFS of the disclosed ecosystem is a decentralized peer-to-peer file sharing network of servers hosted in multiple physical and cloud locations including a proprietary datacenter (e.g., Azure Cloud®), such as Regional Datacenter 304(a) or 304(b), and in internal datacenters of Financial Institutions that are participants in the ecosystem. The IPFS Network enables the secure and efficient sharing of large amounts of files and data. Additionally, every file that is uploaded to the IPFS server 136 is also recorded in the Integrated Platform's Blockchain 112. Some of the benefits for companies using these features are data security, efficient data sharing, traceability of data and files, increased data availability, reduced costs, and improved compliance.

Data Security: IPFS uses advanced cryptographic algorithms to secure data both while in transit and at rest. This helps to prevent unauthorized access to sensitive financial data, such as customer records, financial statements, and transaction details. Different server nodes store parts of the pieces that make up the complete file, and the file can only be reassembled from these smaller pieces and from different locations when downloaded with an authorized key. This means that files stored on IPFS are distributed across many different nodes, making it difficult for anyone to manipulate or censor the content.

Efficient Data Sharing: IPFS enables fast and efficient sharing of large amounts of data between financial institutions, customers, and other stakeholders like government agencies. This helps streamline financial processes, such as loan processing, transfer of ownership of securities, and investment management.

Traceability of Data and Files: When a file is added to the Integrated Platform's IPFS network, it is broken up into smaller pieces and each piece of the file is given a unique hash that represents its content. These hashes are then used to create a cryptographic link between the smaller pieces, which creates a unique identifier for the entire file. If a change to the file or data is uploaded, the smaller hashes would not match, thus creating an updated version of the same file and tracing this update in the system.

Increased Data Availability: An IPFS stores data in a distributed network of nodes, making it highly available and resilient to network failures. This ensures that critical financial data is always accessible, even in the event of a natural disaster or other electronic disruptions, as the disclosed IPFS technology discovers active nodes within the network to consistently permit users access to their data, ensuring that users have stable and uninterrupted access to their data.

Reduced Costs: IPFS can help to reduce the cost of data storage and transfer, as it eliminates the need for centralized data storage and expensive network infrastructure and therefore lowers operational costs.

Improved Compliance: IPFS assists financial institutions to comply with data privacy and security regulations, such as GDPR and HIPAA. IPFS helps financial institutions demonstrate compliance with these regulations by providing a secure and auditable record of data access and sharing.

Smart Contracts, which are self-executing contracts with the terms of the agreement written into code, can be used to automate many aspects of financial technology. One such example is using Smart Contracts to automate investor disbursements based on the predetermined waterfall detailed in any agreement.

All parties involved in a Smart Contract first need to agree to the terms of the Smart Contract before it can be executed. Then, the Smart Contract is coded and recorded to the Blockchain; it runs automatically and enforces the rules and conditions of the contract that has been agreed upon by all the parties. Before a Smart Contract can be executed, all parties must first review and agree to the terms of the contract code. Once all parties review and agree to the details of the Smart Contract code, the Integrated Platform executes the terms of the agreement.

The Smart Contract then runs automatically, and the outcomes of the contract will be recorded on the Blockchain for all parties to see. This outlined process highlights how the Integrated Platform automates payment disbursements to the parties involved, and this technology ensures that each participant in a specific Smart Contract quickly and efficiently receives their share of the income. The automation process removes human error while ensuring that every rule and detail placed in the Smart Contract is followed appropriately.

### Fintech Software Suite

The Integrated Platform may provide a Fintech software suite which is a set of applications designed to help financial institutions manage their day-to-day tasks. These applications include trust accounting, invoicing and billing, loan servicing, fund management, state compliance matrix, collection tracker, CFPB rules, securitization loan servicing, and mortgage pool management.

Overall, the Fintech software suite may provide businesses with a comprehensive set of tools for managing their financial operations. By integrating different tools into a single suite, businesses can streamline their financial management processes and improve their overall performance.

APIs, also known as Application Programming Interfaces, are sets of protocols and tools that allow different software applications to communicate and exchange data with each other. APIs play a critical role in enabling the integration of financial services and data with other software applications, other businesses, and other technologies.

The disclosed Fintech software suite may include programmed and live APIs that can manage millions of requests. The Fintech software suite may include an additional suite of APIs that include Blockchain APIs (e.g., API 114), Interplanetary File System (IPFS) APIs (e.g., IPFS API 132), and external Blockchain user APIs (API 114) in order to integrate Blockchain, IPFS, and Smart Contracts into the Integrated Platform.

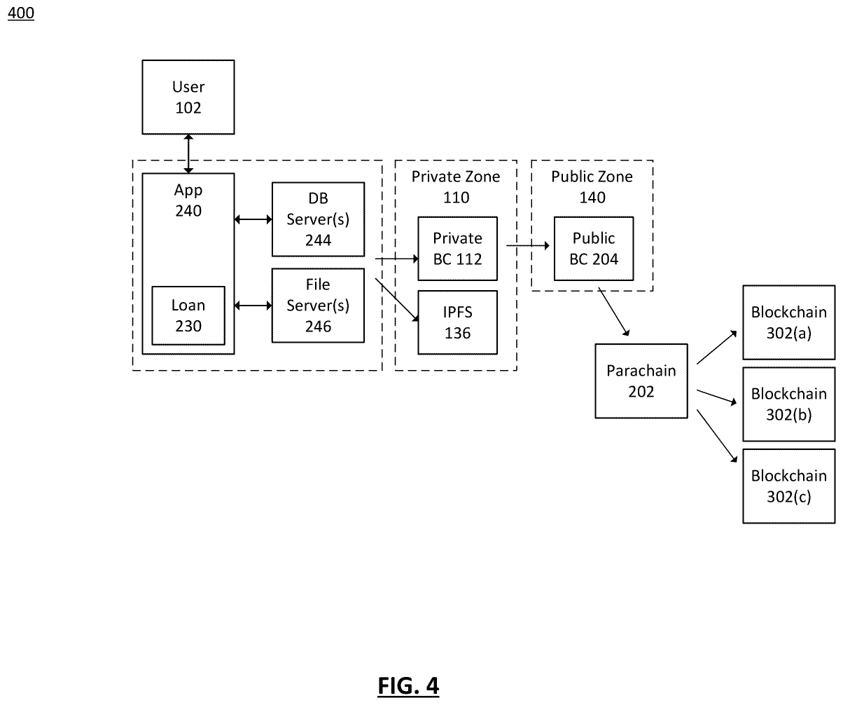

Parachain is a technical mechanism that enables the transfer of financial assets and data between two different Blockchains. Referring to FIG. 4, a Parachain 202 is a separate Blockchain network that is connected to a multi-chain platform that enables the interoperability between different Blockchains, such as interoperability between Public Blockchain 204 and External Blockchains 302(a), 302(b) and 302(c). Additionally, Parachain bridges allow developers to create and deploy decentralized applications (dApps) that are interoperable with other Blockchains, expanding the functionality and potential use cases of the dApps.

In one example implementation of Parachain, the Integrated Platform provides a solution for scaling and optimizing the performance of decentralized networks by allowing them to interact with each other without requiring each network to process every transaction. Overall, a Parachain bridge plays a crucial role in facilitating the interoperability between different Blockchain networks, which is an essential feature for the growth and adoption of Blockchain technology.

A cNFT, or Collateralized Non-Fungible Token, is a digital asset that represents ownership of a unique financial asset that has real physical collateral.

In the context of collateralized real estate loans, the cNFT may be used to represent sole or fractional ownership of a specific mortgage note. The cNFT summarizes asset information such as the original note, mortgage, payment histories, and all documentation that has been uploaded into the Blockchain related to the asset.

The cNFT is a Zero-Knowledge Proof of a defined asset. For example, standard single family home loans are represented by the mortgage/deed. The mortgage/deed is the instrument that secures a Promissory Note for real estate, which is backed by the physical property. This defined asset may be recorded as security inside the Fintech Network, making cNFT representative of the amount secured. Additionally, cNFT collateral assets may be serviced by regulated financial institutions in the United States, making the cNFT of the disclosed ecosystem a compliant financial asset first introduced as part of the ecosystem's Lender Service's efforts to enhance customer's timelines and experiences. This provides assurance to buyers of the asset that they are purchasing a legitimate asset and assures a potential new lender that they have sufficient collateral to secure the loan that collateralizes the cNFT.

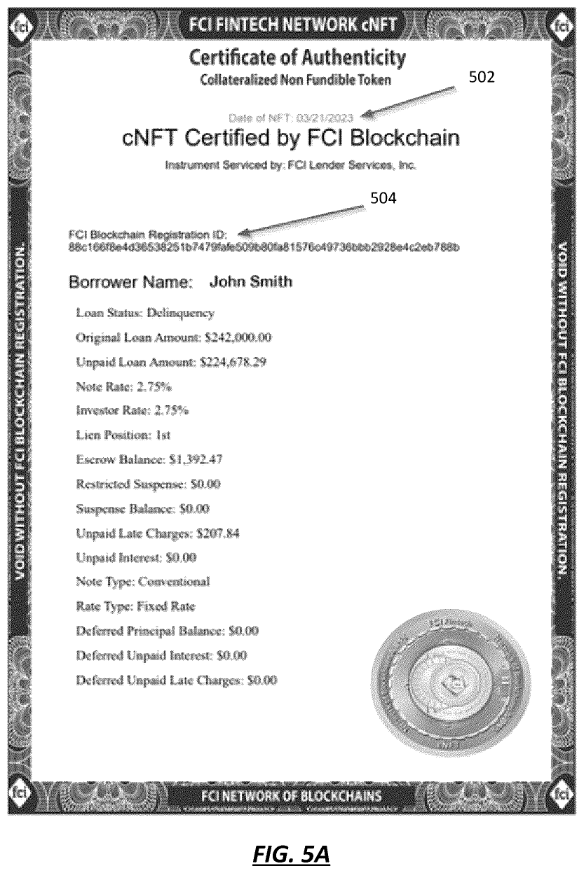

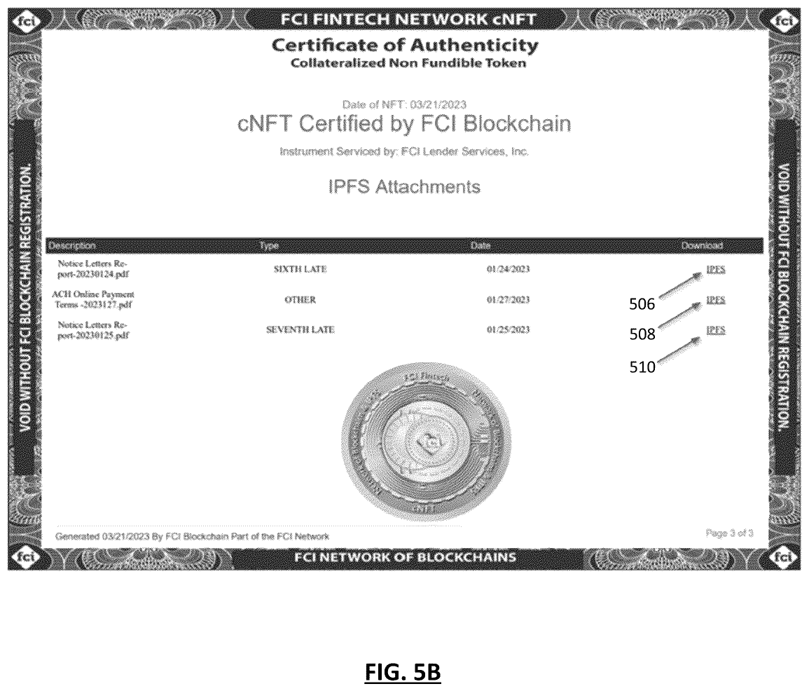

FIGS. 5A and 5B illustrate an example cNFT Certificate of Authenticity that may be generated. Referring to FIG. 2B, a cNFT certificate may be generated by a smart contract 120 and/or stored on IPFS 136. As shown in FIG. 5A, the certificate displays a record of the current real-time status of the asset, memorializing the date of the cNFT's reporting, shown by the top arrow 502. The use of a Blockchain Explorer displays up-to-date data for the asset alongside asset values at the time of recording. Additionally, as seen by the second arrow 504, the cNFT Certificate of Authenticity includes the Blockchain Registration ID used to validate the data.

FIG. 5B illustrates an additional page of the example cNFT Certificate of Authenticity. Additional information indicates the ownership of the asset and, as seen by the arrows 506, 508 and 510, may include clickable links to the IPFS Network 136 for every document recorded for that asset, which improves transparency for the asset and makes the process more efficient.

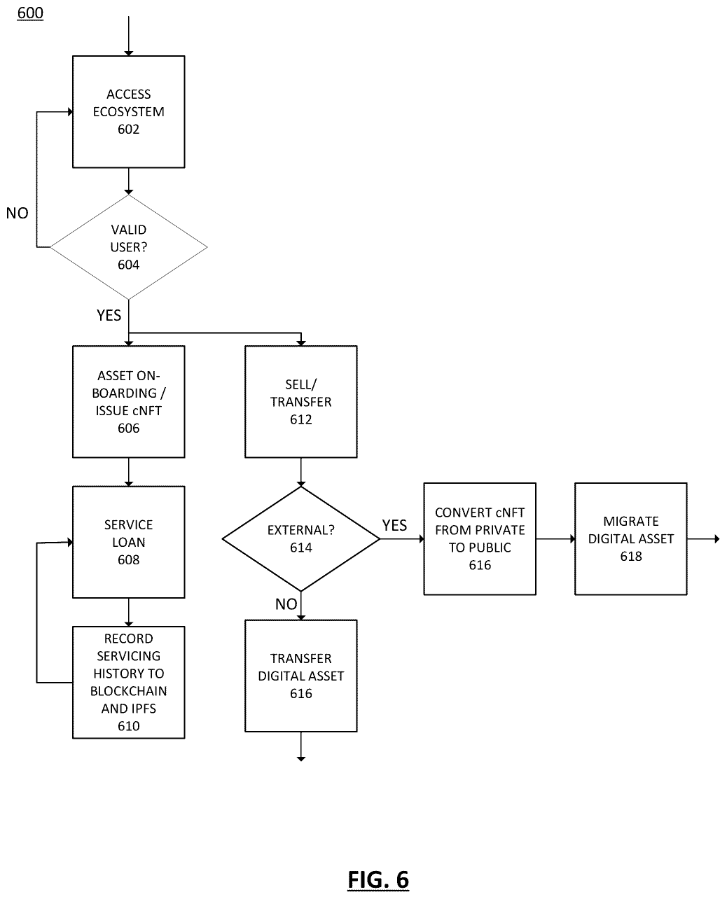

Referring to FIG. 6, flow chart illustrates a method 600 of how a service, such as Lender Services, may use the combination of the disclosed Fintech software suite, IPFS, Blockchain, and API technologies to create, manage, and transfer cNFTs. Taken together, the ecosystem's cNFT technology may change how Capital Markets lend to investors, how a finance company (e.g., Fannie Mae®) repurchases loans from hedge funds, as well as how any physical asset such as mortgages, bonds, real estate recordings, and automobiles can be originated, managed, and transferred.

Method 600 may begin at Step 602 where a user requests access to the Integrated Platform, such as User 102 requesting access to the Integrated Platform within Private Zone 110 of FIG. 1C. Identity of the user may be verified at Step 604 by an API, such as Identity API 126 of FIG. 1C. If the user is authorized, in Step 606 the user may conduct asset on-boarding. For example, an investor services a mortgage loan with Lender Services and the financial asset holder provides all the origination and collateral loan files during the on-boarding process for processing. During on-boarding, the asset's information is simultaneously recorded to a blockchain and an IPFS. For example, asset information may be simultaneously recorded to IPFS 136 and Private Blockchain 112. Once recorded on the blockchain, such as blockchain 112, a private cNFT may be issued by a smart contract, such as smart contract 120.

In Step 608, Lender Services performs its day-to-day onboarding of the loan and in real-time the APIs send recorded servicing history like regular payments to the Blockchain. In Step 610, servicing history is simultaneously recorded to a blockchain and an IPFS. For example, servicing history may be simultaneously recorded to IPFS 136 and Private Blockchain 112.

In Step 612, if the investor who owns the asset wants to sell or transfer the financial asset outside of the Integrated Platform (External? 614=YES), the Smart Contract will convert 616 the Private cNFT to a Public cNFT and migrate 618 the asset to a Public Blockchain. Once the Public cNFT is on the Public Blockchain, the Public cNFT is ready to be transferred through the Parachain technology to a wider market with multiple exit options.

If the ownership is being transferred internally (External? 614=No) within the ecosystem, such as another user that has access to the Private Blockchain and Private IPFS with the Private Zone, the asset holder can share or transfer ownership of the asset to another user and a new cNFT may be issued. In some examples, if an asset holder is selling or transferring privately, Parachain technology can post the asset to other Blockchain markets, like Ethereum, for data auditing purposes.

### Exemplary Electronic Computing Devices

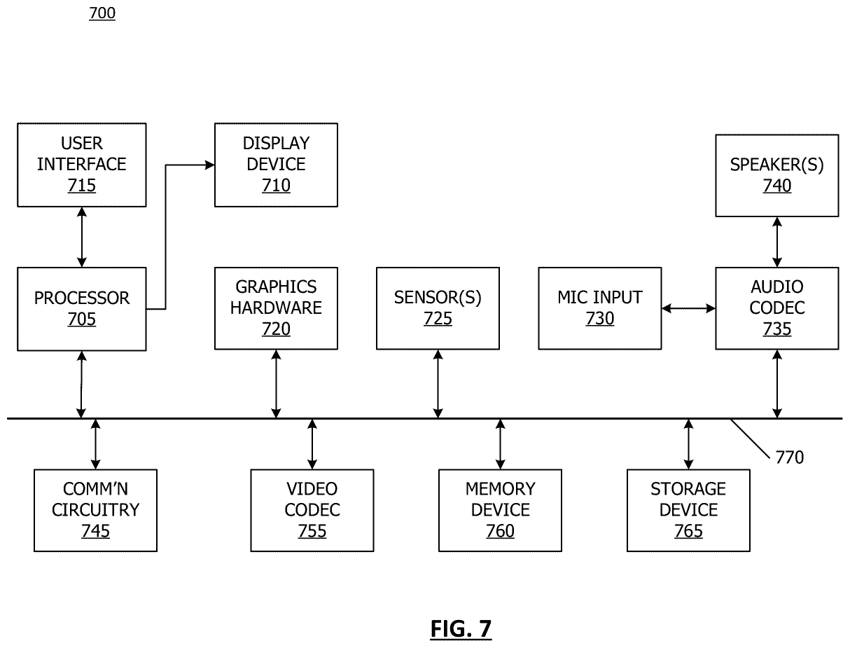

Referring now to FIG. 7 illustrates a simplified functional block diagram of illustrative programmable electronic computing device 700 is shown according to one embodiment. Electronic device 700 may be, for example, a mobile device (e.g., a cell phone), personal media device, portable camera, a tablet PC, laptop, desktop computer system, or the like. As shown, electronic device 700 may include processor 705, display 710, user interface 715, graphics hardware 720, device sensor(s) 725 (e.g., proximity sensor/ambient light sensor, gyroscope, etc.), microphone input 730, audio codec(s) 735, speaker(s) 740, communications circuitry 745, video codec(s) 755, memory 760, storage 765, and communications bus 770.

Processor 705 may execute instructions necessary to carry out or control the operation of many functions performed by electronic device 700. Processor 705 may, for example, drive display 710 and receive user input from user interface 715. User interface 715 can take a variety of forms, such as a button, keypad, dial, a click wheel, keyboard, display screen and/or a touch screen. User interface 715 could, for example, be the conduit through which a user may upload asset information and interact with the disclosed integrated platform. Processor 705 may be a system-on-chip (SOC) such as those found in mobile devices and include one or more dedicated graphics processing units (GPUs). Processor 705 may be based on reduced instruction-set computer (RISC) or complex instruction-set computer (CISC) architectures or any other suitable architecture and may include one or more processing cores. Graphics hardware 720 may be special purpose computational hardware for processing graphics and/or assisting processor 705 perform computational tasks. In one embodiment, graphics hardware 720 may include one or more programmable graphics processing units (GPUs) and/or one or more specialized SOCs, e.g., an SOC specially designed to implement neural network and machine learning operations (e.g., convolutions) in a more energy-efficient manner than either the main device central processing unit (CPU) or a typical GPU, such as a neural engine processing core.

Memory device 760 may include one or more different types of media used by processor 705 and/or graphics hardware 720 to perform device functions. For example, memory 760 may include memory cache, read-only memory (ROM), and/or random-access memory (RAM). Storage 765 may store media (e.g., asset data and information, audio, image and video files), computer program instructions or software, preference information, device profile information, and any other suitable data. Storage 765 may include one more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 760 and storage 765 may be used to retain computer program instructions or code organized into one or more modules and written in any desired computer programming language. When executed by, for example, processor 705, such computer program code may implement one or more of the methods or processes described herein.

### ADDITIONAL CONSIDERATIONS

Reference in this disclosure to “one embodiment” or to “an embodiment” means that a particular feature, structure, or characteristic described in connection with the embodiment is included in at least one embodiment, and multiple references to “one embodiment” or to “an embodiment” should not be understood as necessarily all referring to the same embodiment or to different embodiments.

As will be appreciated based upon the foregoing specification, the above-described embodiments of the disclosure may be implemented using computer programming or engineering techniques including computer software, firmware, hardware or any combination or subset thereof. Any such resulting program, having computer-readable code, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor and can be implemented in a high-level procedural and/or object-oriented programming language, and/or in assembly/machine language. As used herein, the terms “machine-readable medium” or “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are examples only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are examples only and are thus not limiting as to the types of memory usable for storage of a computer program.

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various environments without compromising any major functionality. In some embodiments, the system may include multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

A blockchain explorer is a web-based tool or interface that allows users to explore and interact with a blockchain network. It provides a transparent view of the blockchain's transaction history, enabling users to search for specific transactions, addresses, or blocks, and retrieve detailed information about them, such as timestamps, transaction amounts, and participants involved. Blockchain explorers typically offer a user-friendly interface that displays data in a readable format, including charts and graphs to visualize network activity and statistics. They play a crucial role in enhancing transparency, accountability, and trust within blockchain ecosystems by offering real-time access to the distributed ledger's data.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

What is claimed is:

1. A device, comprising:
a memory; and
one or more processors operatively coupled to the memory, wherein the one or more processors are configured to execute instructions causing the one or more processors to:
receive, from a user device, information associated with at least one asset;
record the information associated with the at least one asset to a private blockchain and an Interplanetary File System (IPFS);
generate a private digital asset representing the at least one asset based at least in part on the information;
record the private digital asset to the private blockchain and the Interplanetary File System (IPFS);
in response to receiving a transfer request, convert the private digital asset to a public digital asset; and
migrate the public digital asset to a public blockchain.

2. The device of claim 1, wherein the information associated with the at least one asset includes one or more of loan origination files, collateral loan files, loan payment history, and loan ownership history.

3. The device of claim 1, wherein the private digital asset is a private collaterized non-fungible token (cNFT), wherein the private cNFT represents ownership of the at least one asset.

4. The device of claim 3, wherein the at least one asset has physical collateral.

5. The device of claim 3, wherein the cNFT represents sole or fractional ownership of the at least one asset.

6. The device of claim 1, wherein the information associated with the at least one asset is simultaneously recorded to the private blockchain and the Interplanetary File System (IPFS).

7. The device of claim 1, wherein the one or more processors are further configured to:
generate a hash of the private digital asset; and
transmit the hash of the private digital asset to the user device for subsequent retrieval of the private digital asset.

8. The device of claim 1, wherein the one or more processors are further configured to:
generate a certificate of authenticity of the private digital asset, wherein the certificate of authenticity provides a record of the current real-time status of the private digital asset and memorializes the data of the private digital asset's reporting.

9. A non-transitory computer readable medium comprising instructions that, when executed by a processor, implement:
receiving, from a user device, information associated with at least one asset;
recording the information associated with the at least one asset to a private blockchain and an Interplanetary File System (IPFS);
generating a private digital asset representing the at least one asset based at least in part on the information;
recording the private digital asset to the private blockchain and the Interplanetary File System (IPFS);
in response to receiving a transfer request, converting the private digital asset to a public digital asset; and
migrating the public digital asset to a public blockchain.

10. The non-transitory computer readable medium of claim 9, wherein the information associated with the at least one asset includes one or more of loan origination files, collateral loan files, loan payment history, and loan ownership history.

11. The non-transitory computer readable medium of claim 9, wherein the private digital asset is a private collaterized non-fungible token (cNFT), wherein the private cNFT represents ownership of the at least one asset.

12. The non-transitory computer readable medium of claim 11, wherein the at least one asset has physical collateral.

13. The non-transitory computer readable medium of claim 11, wherein the cNFT represents sole or fractional ownership of the at least one asset.

14. The non-transitory computer readable medium of claim 9, wherein the information associated with the at least one asset is simultaneously recorded to the private blockchain and the Interplanetary File System (IPFS).

15. A method, comprising:
receiving, from a user device, information associated with at least one asset;
recording the information associated with the at least one asset to a private blockchain and an Interplanetary File System (IPFS);
generating a private digital asset representing the at least one asset based at least in part on the information;
recording the private digital asset to the private blockchain and the Interplanetary File System (IPFS);
in response to receiving a transfer request, converting the private digital asset to a public digital asset; and
migrating the public digital asset to a public blockchain.

16. The method of claim 15, wherein the information associated with the at least one asset includes one or more of loan origination files, collateral loan files, loan payment history, and loan ownership history.

17. The method of claim 15, wherein the private digital asset is a private collaterized non-fungible token (cNFT), wherein the private cNFT represents ownership of the at least one asset.

18. The method of claim 17, wherein the at least one asset has physical collateral.

19. The method of claim 17, wherein the cNFT represents sole or fractional ownership of the at least one asset.

20. The method of claim 15, wherein the information associated with the at least one asset is simultaneously recorded to the private blockchain and the Interplanetary File System (IPFS).
